(19) United States
(12) Patent Application Publication
(10) Pub. No.: US 2016/0088666 A1
(43) Pub. Date: Mar. 24, 2016

(54) METHOD AND DEVICE FOR MANAGING THE CONNECTIVITY OF A TERMINAL BY MEANS OF A MOBILE SERVER IN A TELECOMMUNICATIONS NETWORK

(71) Applicant: AIRBUS DS SAS, Elancourt (FR)

(72) Inventor: Olivier PATEROUR, Guyancourt (FR)

(21) Appl. No.: 14/777,969

(22) PCT Filed: Feb. 4, 2014
(86) PCT No.: PCT/EP14/00279

§ 371 Date: Sep. 17, 2015

(30) Foreign Application Priority Data
Mar. 18, 2013 (FR) 1352389

(51) Int. Cl. H04W 76/02; H04W 48/18; H04W 48/16; H04W 8/18; H04W 12/08

(52) U.S. Cl. CPC H04W 76/021; H04W 8/18; H04W 12/08; H04W 48/16; H04W 48/18

(57) ABSTRACT

A mobile server for managing the connectivity of a terminal for communicating through one or more communications networks, includes: a terminal communication module to communicate with the terminal; network communication modules to communicate with telecommunications networks; and a storage area, in which connectivity parameter values of the terminal are stored, the values enabling the terminal to be connected to the mobile server. The mobile server is configured to be connected to a plurality of telecommunications networks via the network communication modules, to extract a set of connectivity parameter values of the terminal from the storage area, and to allow or not allow, based on the extracted set of connectivity parameter values, the connection of the terminal via at least one of the terminal communication modules, so that the terminal communicates applicative data through a telecommunications network via the terminal communication module and one of the network communication modules.

### TECHNICAL FIELD AND OBJECT OF THE INVENTION

The present invention relates to the field of telecommunications and more particularly to the management of the connectivity of a terminal for communicating through a telecommunications network.

The present invention thus relates to a mobile server, a system and a method for managing the connectivity of at least one terminal via a mobile server for communicating through at least one telecommunications network.

### STATE OF THE PRIOR ART

In a known manner, a terminal connects to a telecommunications network in order to exchange applicative data with, for example, another terminal or an application server, on a communication link established through said network. Such a telecommunications network may be a network of the Wireless Local Area Network (WLAN) type or the Wireless Wide Area Network (WWAN) type such as for example a Global System for Mobile (GSM) Communications, Universal Mobile Telecommunications System (UMTS) or Long-Term Evolution Advanced (4G-LTE Advanced) network. The terms “applicative data” are taken to mean applicative level data (level 7) in the Open Systems Interconnection (OSI) model, such as for example vocal communication data, files, etc.

In order to connect to a network, the terminal has to obtain beforehand connectivity parameters enabling it to establish said communication link. Such connectivity parameters are stored in a known manner in the storage area of a connection server connected to the network which communicates them to the terminal, for example on request, through the network. The terminal then uses the connectivity parameters received to connect to the network at the level of a fixed entity of the network called fixed access point, such as for example a gateway or a terminal integrated in the network, in order to be able to exchange applicative data through the network with another terminal or an application server.

However, it is not always possible for a terminal to connect to such an access point, for example, when the terminal is mobile but is not in the network coverage of the access point or instead when it is not able to communicate with the access point.

In order to overcome these drawbacks, it is known for a terminal to connect at a mobile access point (or MAP) to the network which is able to establish a connection through said network in order to communicate via said mobile access point through the network.

However, the mobile access point must firstly establish a communication link with the connection server through the network to obtain the connectivity parameters of the terminal in order to allow the terminal to connect to the mobile access point and to communicate through the access point and the network, which is time-consuming and complex and thus is a drawback.

Furthermore, the exchange of connectivity parameters between the connection server and the mobile access point on the one hand and/or the management of the connectivity of the terminal via the mobile access point on the other hand are generally carried out using a so-called specific “proprietary” protocol and it is then necessary that the connection server is able to manage the different proprietary protocols used by the different types of mobile access points, which is another drawback.

### GENERAL DESCRIPTION OF THE INVENTION

The aim of the present invention is to overcome these drawbacks by proposing a simple, open and efficient solution for managing the connectivity of a terminal or several terminals of different types via a mobile server for the communication, via said mobile server, through one or a plurality of telecommunications networks.

To this end, the invention firstly relates to a mobile server for managing the connectivity of at least one terminal for communicating through one or a plurality of telecommunications networks, the mobile server including:
at least one terminal communication module configured to communicate with said terminal,
a plurality of network communication modules configured to communicate with a plurality of telecommunications networks,
a storage area in which are stored connectivity parameter values of the terminal enabling the terminal to connect to the mobile server, the mobile server being configured to:
connect to a plurality of telecommunications networks via the plurality of network communication modules,
extract a set of connectivity parameter values of the terminal from the storage area,
allow or not allow, on the basis of the extracted set of connectivity parameter values, the connection of the terminal via at least one of the terminal communication modules so that the terminal can communicate applicative data through at least one of the telecommunications networks via at least said terminal communication module and at least one of the network communication modules.

The terms “set of connectivity parameter values” are taken to mean one or a plurality of parameter values making it possible to allow or not allow the connection of a terminal to the mobile server for the communication of the terminal via the mobile server through at least one of the telecommunications networks.

The mobile server according to the invention is thus a mobile access point configured to manage locally the connectivity of one or a plurality of terminals, preferably of different types, and allow them to communicate through one or a plurality of networks, preferably of different types, via the mobile server.

The mobile server thus manages locally, on the one hand, its own connectivity to one or more networks then, on the other hand, the connectivity of the terminals to the mobile server. Once the terminal or terminals connected to the mobile server, said mobile server acts as a relay for the communication of applicative data from the terminal or terminals through the network or the networks.

The terminals are thus not connected directly to a network, which makes it possible to simplify their connection on different terminal communication modules since this is managed in a centralised manner by the mobile server and which also makes it possible to avoid the management of the connectivity of the terminal or terminals directly by a connection server situated in the network. Such a centralisation of the management of the connectivity of the terminal or terminals at the level of the mobile server makes their connection to the network(s), via the mobile server, easy and efficient.

The mobile server may moreover move while managing its own connectivity to the network without there being need to modify the connectivity of the terminal or terminals which are already connected to it. In other words, the mobile server locally manages the connectivity of the terminal or terminals which thus do not need to re-connect at a different fixed point to the network as the mobile server and the terminal or the terminals move, the mobile server itself managing the connection to the network(s), for example through one or more fixed access points to the network.

Each network communication module enables the mobile server to communicate with one of the networks and may be for example based on the norms Wireless Wide Area Network (WWAN), Wireless Local Area Network (WLAN). The mobile server may also advantageously include a plurality of modems of WWAN or WLAN type each enabling access to a different telecommunications network or different access to a same telecommunications network. The telecommunications network(s) may be for example of the WWAN, WLAN, Private Mobile Radio (PMR), satellite type, etc.

The plurality of network communication modules can enable the mobile server to establish, for a given terminal, a first communication link with a first telecommunications network and a second communication link with a second telecommunications network. Thus, for example, if one of the network communication modules or one of the communication links is defective, the communication of applicative data exchanged on the defective communication link may be switched over entirely onto the non-defective communication link. Also for example, authentication data from the terminal to the network may be communicated on the first communication link and applicative data may be communicated on the second communication link.

A terminal communication module may be, for example, based on the norm of the Ethernet Local Area Network (LAN) or instead Universal Serial Bus (USB) or even Wireless Local Area Network (WLAN) type for which the module may be a WLAN server. A plurality of terminal communication modules of different types advantageously enables a plurality of terminals to connect to the network(s) via the mobile server in a different manner (WLAN, USB cable, Ethernet cable, etc.) and simultaneously. In this case, the mobile server is configured to supply a set of connectivity parameter values, for example different, to each terminal.

In order to allow or not allow the communication of applicative data of the terminal through at least one of the telecommunications networks via the terminal communication module and at least one of the network communication modules, the mobile server is preferably configured to:
establish a connection with a terminal via at least one of the terminal communication modules, for example of WLAN or LAN type, to exchange information items enabling the access control of the terminal and/or the network addressing configuration of the terminal and/or,
analyse and/or compare an information item received from a terminal enabling the access control of said terminal on the basis of the set of connectivity parameter values extracted from the storage area, and/or,
determine the network addressing configuration of a terminal, for example by allocating a network address, for example of the Internet Protocol (IP) type, to a terminal on the basis of a set of network addressing configuration parameter values extracted from the storage area,
supply to the terminal one or more values of the set of connectivity parameter values extracted from the storage area, such as for example an IP, and/or,
allow the authentication of the terminal, for example locally from authentication parameters stored in the storage area or instead remotely while communicating with an authentication server situated in one of the networks, for example using an authentication protocol based on the known norm 802.1x.

An information item enabling the control of access of a terminal to the mobile server may be, for example, the Medium Access-Control (MAC) physical address of the terminal which is unique. The terms “physical address” are taken to mean the MAC address or identifier of the terminal of the type at the level of the link layer of the Open Systems Interconnection (OSI) model.

The MAC address may be filtered, that is to say compared, according to the filtering rules defined in the connectivity parameters stored in the storage area. For example, the filtering may consist in determining whether the MAC address forms part of a list of MAC addresses allowed (“white list”) or not allowed (“black list”) stored in the storage area in a filtering list parameter.

According to a characteristic of the invention, the connectivity parameters are organised in the storage area in the form of a tree structure including a plurality of hierarchized objects each grouping together one or a plurality of connectivity parameters.

Preferably, the tree structure is of the Open Mobile Alliance (OMA) type and the objects are manipulated using the Open Mobile Alliance Device Management protocol. The OMA “Device Management” (OMA DM) protocol developed within the scope of Open Mobile Alliance makes it possible to realise the connection of a mobile access point to a network through its object “Connectivity Management” which defines a sub-part “Network Access Point” but did not make it possible, before the present invention, to manage the connectivity of one or more terminals to a mobile access point in order that they communicate through the network.

The use of such an open protocol allows the mobile server to connect to any type of network of which the connectivity parameters are organised according to the OMA model whereas existing mobile router solutions are based on the use of a specific proprietary protocol incompatible with a network of which the connectivity parameters are organised according to the OMA model and manipulated using the OMA DM protocol.

The connectivity parameter values may be copied in the storage area from a connection server situated in at least one of the networks. In this case, the connection server includes an OMA server and the mobile server includes an OMA client. The connectivity parameter values may be copied in the storage area for example a first time in the factory then later updated on request of the mobile server (so-called “pull” mode) or on sending from the connection server (so-called “push” mode).

A plurality of objects specific to the mobile server may thus be defined at the level of the mobile server in the form of OMA objects, particularly for managing the connectivity of terminals on communication interfaces of different types.

Thus, for example, the mobile server can manage the connection of a terminal through a communication link of the WLAN or LAN type, the attribution of Internet Protocol (IP) network addresses to the terminals, the filtering of MAC physical addresses of the terminals and/or the authentication of the terminals, which would not manage a fixed access point to the network of the prior art. These functions may be defined in objects of the OMA tree structure stored in the storage area of the mobile server.

The OMA model is moreover simple and easy to use such that it is particularly suitable for managing the connectivity of a terminal. The use of a tree structure of the OMA type for managing connectivity locally at the level of the mobile server makes it possible to overcome certain drawbacks. In fact, in the prior art, the management of the connectivity of a terminal is managed differently depending on whether the terminal connects to the network directly (management of the connectivity by the network) or via a mobile access point (proprietary protocol management). Furthermore, in the prior art, the connectivity parameters are not organised in the form of a tree structure of OMA type which makes it possible to notably simplify their storage, their management and the communication of their values between the mobile access point and the OMA DM server on the one hand and between the mobile access point and the terminal or the terminals on the other hand. The use of a tree structure of OMA type enables the mobile server to be compatible with any network of which the connectivity parameters are organised according to the open OMA model.

Advantageously, the mobile server includes a router to shunt the applicative data of a terminal through the network or networks.

The invention also relates to a system for managing the connectivity of at least one terminal to at least one telecommunications network, said system including:
at least one telecommunications network, preferably a plurality,
a mobile server as described previously,
at least one terminal configured to:
   establish a connection via at least one of the terminal communication modules, for example of WLAN or LAN type, to exchange information items enabling the access control of said terminal and/or the network addressing configuration of said terminal and/or,
   communicate applicative data through at least one of the telecommunications networks via at least one of the terminal communication modules and at least one of the network communication modules.

Preferably, the terminal is configured to receive, from the mobile server, at least one value of the set of connectivity parameter values extracted from the storage area enabling it to connect to the mobile server via a terminal communication module.

According to an aspect of the invention, the system includes a plurality of terminals, preferably of different types, connected to the mobile server. For example, a first terminal may be of the smartphone or tablet type and a second terminal may be of the computer type, for example portable.

The invention also relates to a method, implemented by a mobile server as described previously, for managing the connectivity of at least one terminal for the communication of the terminal via the mobile server through one or a plurality of telecommunications network(s), the method including:
a step of connecting to at least one of a plurality of telecommunications networks via at least one of the plurality of network communication modules,
a step of extracting a set of connectivity parameter values of the terminal from the storage area,
a step of allowing or not allowing, from the extracted set of connectivity parameter values, the connection of the terminal via at least one of the terminal communication modules such that the terminal can communicate applicative data through at least one of the telecommunications networks via at least said terminal communication module and at least one of the network communication modules.

Preferably, the method includes:
a step of connecting a terminal via at least one of the terminal communication modules, for example of WLAN or LAN type, to exchange information items enabling the access control of the terminal and/or the network addressing configuration of the terminal and/or,
a step of analysing and/or filtering an information item received enabling the access control of a terminal from the set of connectivity parameter values extracted from the storage area, and/or,
a step of determining the network addressing configuration of a terminal, for example by allocating a network address, for example of the Internet Protocol (IP) type, to a terminal from a set of network addressing configuration parameter values extracted from the storage area, and/or,
a step of supplying to a terminal one or more values of the set of connectivity parameter values extracted from the storage area, such as for example an IP address network, and/or,
a step of authentication of a terminal, for example locally from authentication parameters stored in the storage area or instead remotely while communicating with an authentication server situated in one of the networks, for example using an authentication protocol based on the known norm 802.1x

and/or,
a step of communication of a terminal through the network or networks via the terminal communication module(s) and at least one network communication module.

The step of analysing an information item received enabling the access control of a terminal may consist, for example, of a step of filtering a MAC physical address as described previously.

The filtering and the authentication may be carried out by type of terminal communication module (WLAN, Ethernet, USB, etc.). The method may also include a preliminary step of reception of the MAC physical address of the terminal.

Also preferably, the step of supply includes the supply of authentication parameters of the terminal and/or configuration parameters of the address network of the terminal and/or radio or wire access parameters. The supply of these parameter values by the mobile server notably makes it possible to avoid the terminal making a request to the network.

The invention also relates to a support including instructions executable by a computer for the implementation of the method described previously.

Other characteristics and advantages of the invention will become clearer from the description that follows made with regard to the appended figures given as non-limiting examples and in which identical references are given to similar objects.

### DESCRIPTION OF THE FIGURES

FIG. 1 illustrates the system for managing connectivity according to the invention.

FIG. 2 illustrates a form of embodiment of the control module of the mobile server according to the invention.

FIG. 3 illustrates an example of tree structure of the “Vendor” object of the tree structure of connectivity parameters used by the mobile server according to the invention.

FIG. 4 illustrates an example of tree structure of the object “MAP” of the tree structure of FIG. 3.

FIG. 5 illustrates an example of tree structure of the object “IP” of the tree structure of FIG. 4.

FIG. 6 illustrates an example of tree structure of the object “WLAN” of the tree structure of FIG. 4.

FIG. 7 illustrates an embodiment of the method according to the invention.

### DETAILED DESCRIPTION OF THE INVENTION

### Description of the System According to the Invention

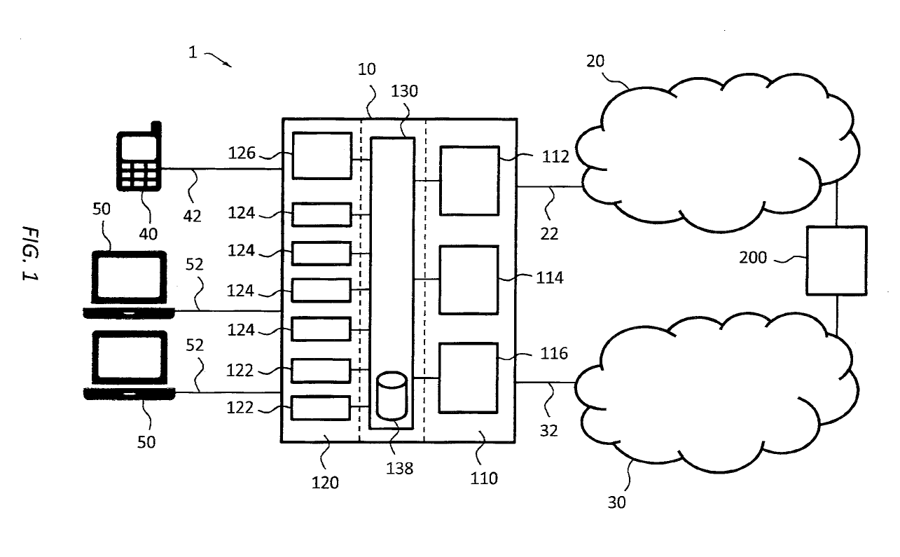

As illustrated in FIG. 1, the system 1 according to the invention includes a mobile server 10, a first telecommunications network 20, a second telecommunications network 30 and a plurality of terminals (40, 50) connected to the mobile server 10 via a plurality of communications links (42, 52).

A wireless terminal 40, for example of the smartphone or tablet type, is connected to the mobile server 10 via a wireless link 42. Such a wireless link 42 may be for example a link of the Wireless Local Area Network (WLAN) or Bluetooth® type or any type of link using a wireless protocol.

Still with reference to FIG. 1, two computers 50 of the portable computer type are connected to the mobile server 10 via links 52. The link 52 may be of the Ethernet Local Area Network (LAN) wire link type, or instead a “Universal Serial Bus” (USB) wire link by cable, or any type of wire link, or instead wireless link for example of the Wireless Local Area Network (WLAN) or Bluetooth® type or any type of link using a wireless protocol.

The server 10 is mobile, that is to say that it is capable of moving and is not connected to a network by a cable. It is configured to be connected to one or to a plurality of telecommunications networks on a wireless communication link.

In the example illustrated in FIG. 1, the mobile server 10 is connected to a first network 20 via a first communication link 22 and to a second telecommunications network 30 via a second communication link 32.

The first network 20 and the second network 30 may be, for example, of the Wireless Local Area Network (WLAN) type or instead Wireless Wide Area Network (WWAN) type such as for example a GSM, UMTS or LTE Advanced network.

The server being mobile, the communications links 22 and 32 are wireless communication links for example of the Wireless Local Area Network (WLAN), Wireless Wide Area Network (WWAN), satellite network, Private Mobile Communications (PMR) type such as for example a network TETRA, TETRAPOL, P25, etc.

Mobile Server

With reference to FIG. 1, the mobile server 10 includes an access interface 110 to the networks 20 and 30, an access interface 120 from the terminals to the mobile server 10 and a control module 130.

The mobile server 10 is configured to establish one or more communication links 22, 32 with one network or the networks 20, 30 so that the terminals 40, 50 can communicate through the network or networks 20, 30 through the intermediary of the mobile server 10.

In order to route the applicative data of the terminals 40, 50 to the networks 20, 30 or networks 20, 30 to the terminals 40, 50, the mobile server 10 includes a router (not represented).

The control module 130 is configured to manage the connectivity of the mobile server 10 to the networks 20, 30 via the access interface 110, the connectivity of the terminals 40, 50 to the mobile server 10 via the access interface 120 and the communications of applicative data of the terminals 40, 50 through the networks 20, 30 via the router.

The access interface 110 to the networks 20 and 30 includes a plurality of network communication modules 112, 114, 116. In this example, the network communication modules 112 and 116 are WWAN communication modems and the communication module 114 is a modem of the WLAN type.

The access interface 120 of the terminals 40, 50 includes a plurality of terminal communication modules 122, 124, 126 enabling the terminals 40, 50 to communicate with the mobile server 10.

In this example, the mobile access interface 120 includes two USB terminal communication modules 122, four Ethernet LAN terminal communication modules 124 and a WLAN terminal communication module 126.

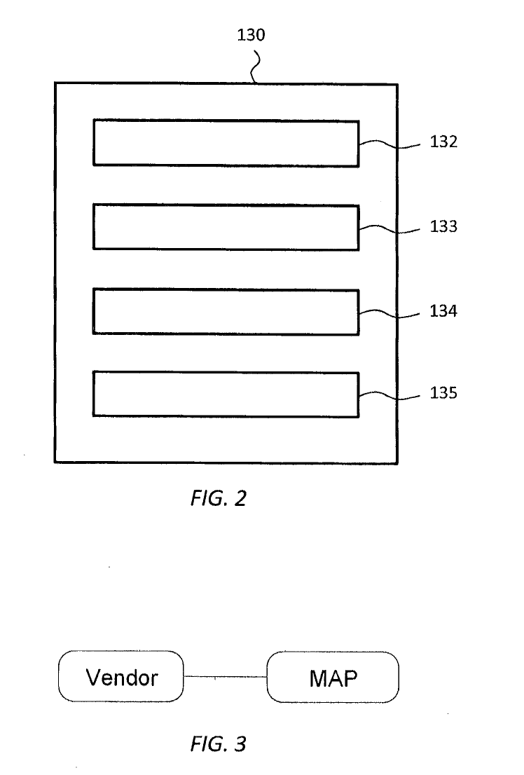

With reference to FIG. 2, in order to manage the connectivity of the terminals 40, 50 to the mobile server 10, the control module 130 of the mobile server 10 includes a module 132 for managing connections, a module 133 for controlling access of the terminals 40, 50, a module 134 for managing the configuration of the protocol network (Internet Protocol or IP) and a module 135 for managing the authentication.

The modules 132, 133, 134, 135 make it possible to obtain the connectivity parameters of the terminals 40, 50 to the mobile server 10 on the different communication terminal modules 122, 124, 126 such that the terminals 40, 50 can connect to the mobile server 10 to be able to communicate applicative data through one network or the networks 20, 30 via the communications links 22, 32.

The control module 130 can also realise other functions, such as for example the management of NAT (Network Address Translation) rules, redirection of ports according to the protocols (TCP, UDP, etc.), the rules of which may be defined for example in the module 134, etc.

The module 132 for managing connections makes it possible to manage the communications between the mobile server 10 and the terminals 40, 50 on the terminal communication modules 122, 124, 126 notably by managing the type of module used (LAN, WLAN, etc.), the port on which a terminal 40, 50 connects to the mobile server 10, etc.

In this example, the module 133 for controlling access of the terminals 40, 50 makes it possible to manage the filtering of the physical addresses of the network interfaces (Media Access Control or MAC) according to the type of connectivity. Since each terminal 40, 50 has a unique MAC address, the mobile server 10 can define a list of MAC addresses allowed or refused enabling a control of access.

The module 134 for managing the configuration of the IP protocol network makes it possible to manage the type of protocol used (for example IPv4 or IPv6), the allocation of IP address, the IP address network (local or global) to reach a domain name server (Domain Name System or DNS) situated in the network 20, 30, etc. The mobile server 10 may include a Dynamic Host Configuration Protocol (DHCP) server which may, for example, allocate to a terminal 40, 50 an IP address in a configured IP address range 10. Alternatively, the DHCP server may be configured in “relay” mode and obtain an IP address to allocate to a terminal 40, 50 a DHCP server situated in the network 20, 30.

The module 135 for managing the authentication makes it possible to manage the authentication of the terminals 40, 50 for example with an authentication server (not represented) situated in the network 20, 30. Such a management may be realised, for example, on the basis of the type of authentication server (Radius, Terminal Access Controller Access-Control System (TACACS) etc.), the local authentication type (identifier, password) or remotely (IP configuration of the server, secret key), etc.

According to an aspect of the invention, the connectivity parameters of the terminals 40, 50 to the mobile server 10 via the communication interfaces 122, 124, 126 are organised in the form of a tree structure based on the model defined in the Open Mobile Alliance (OMA) standard using the OMA Device Management (OMA DM) protocol.

Such a protocol uses tree structures which structure the data in the form of hierarchized nodes. In the mobile server according to the invention, one or more connectivity parameters may be associated with a node and certain nodes may not be associated with connectivity parameters.

The mobile server 10 includes an OMA DM client (not represented) which makes it possible to obtain the connectivity parameters as well as their value, for example an OMA DM server installed on a connection server 200, for example through one or both telecommunications networks 20, 30. The connectivity parameters are stored in a storage area 138, coupled to the control module 130, to enable the local management of the connectivity of the terminals 40, 50 by the mobile server 10 without having need to obtain the parameter values while passing systematically through one of the networks 20, 30. The connectivity parameters and/or their value may also be stored in the storage area 138 for example in the factory while the mobile server 10 is being manufactured.

The tree structure of data according to the model defined by OMA DM may be for example encoded using the Extensible Markup Language (XML) format.

The mobile server 10 implements an OMA DM client for the management of the connectivity of the mobile server 10 to the networks 20, 30, which advantageously makes it possible to use an open protocol for managing terminals at the level of the mobile server 10.

The OMA DM tree structure organising the connectivity parameters of the terminals 40, 50 to the mobile access interface 120 is defined in an object (or node) called “MAP” (Mobile Access Point).

In this example, the object “MAP” is itself attached in the OMA tree structure to a customisable object called “Vendor” as illustrated in FIG. 3. Obviously, the object “MAP” could be defined or attached to any other place of the OMA tree structure.

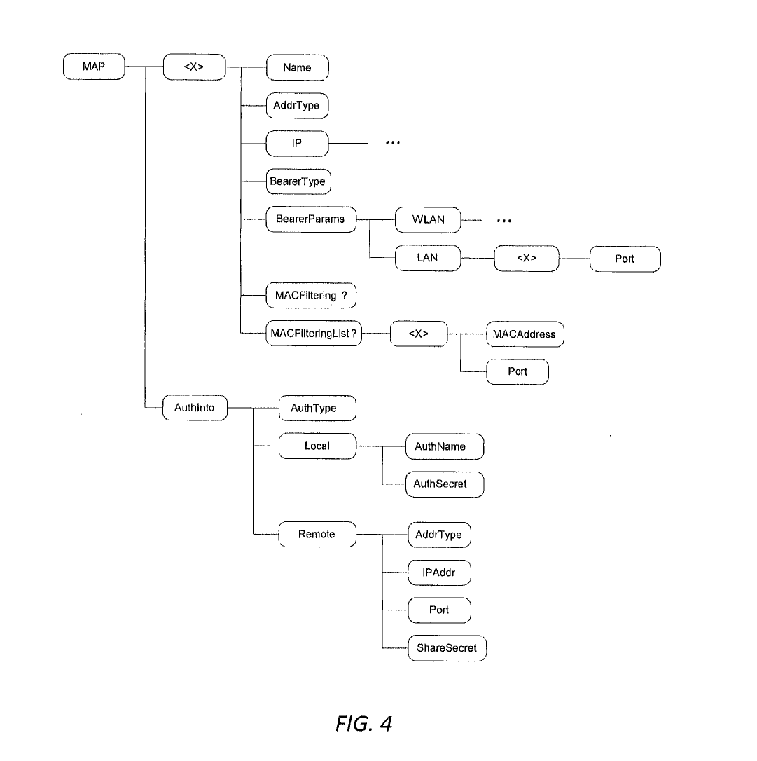

An example of OMA tree structure of the object “MAP” organising the connectivity parameters for the mobile access point 120 is illustrated in FIG. 4. The different nodes of this tree structure may be defined in the following manner:

The object “MAP” defines the connectivity parameters of the terminals 40, 50 to the mobile server 10. The object “MAP/X” defines the unique identifier of the object “MAP” for a given connection support (for example WLAN or LAN). The object “MAP/X/Name” defines the account name. The object “MAP/X/AddrType” defines the format of object Addr (for example “IPv4” or “IPv6”).

The object “MAP/X/IP” defines the management of the IP addressing network as described hereafter.

The object “MAP/X/BearerType” defines the type of support (bearer) used by a terminal to communicate with the mobile access point. The object “MAP/X/BearerParams” defines the parameters of the support used by a terminal to communicate with the mobile access point.

The object “MAP/X/BearerParams/WLAN” defines the sub-tree structure of the WLAN support as described hereafter.

The object “MAP/X/BearerParams/LAN” defines the sub-tree structure of the LAN support. The object “MAP/X/BearerParams/LAN/<X>” defines a logical identifier of port number. The object “MAP/X/BearerParams/LAN/<X>/Port” defines the port number of the LAN module.

The object “MAP/X/MACFiltering” defines the activation of the filtering of MAC address for the module determined (in this example WLAN or LAN). The object “MAP/X/MACFilteringList” defines the list of parameters of additional MAC addresses to filter for a given port. The object “MAP/X/MACFilteringList/<X>” defines different additional MAC addresses to filter for a given port.

The object “MAP/X/MACFilteringList/<X>/MACAddress” defines a MAC address to filter. The object “MAP/X/MACFilteringList/<X>/Port” defines the port on which the MAC address has to be filtered. This parameter is not valid if the type of terminal communication module is “WLAN”.

The object “MAP/AuthInfo” supplies information items of authentication to support various access controls to the network based on the port, using for example the 802.IX protocol. In this example, this object or node is common to the objects WLAN and LAN. Obviously, it is also possible to attach it directly to the object “MAP/<X>” so as to be able to differentiate the information items of authentication depending on the type of connection support (WLAN, LAN etc.)

The object “MAP/AuthInfo/AuthType” defines the type of authentication used for the mobile access point 120.

The object “MAP/AuthInfo/Local” supplies the information items of authentication when the authentication server is local. The object “MAP/AuthInfo/Local/AuthName” defines the user name for the local authentication. The object “MAP/AuthInfo/Local/AuthSecret” defines the password for the local authentication.

The object “MAP/AuthInfo/Remote” supplies the information items of authentication when the authentication server is remote.

The object “MAP/AuthInfo/Remote/AddrType” defines the format of the object IPAddr. The object “MAP/AuthInfo/Remote/IPAddr” defines the IP address of the authentication server. The object “MAP/AuthInfo/Remote/Port” defines the connection port of the authentication server. The object “MAP/AuthInfo/Remote/ShareSecret” defines the password for the authentication remotely.

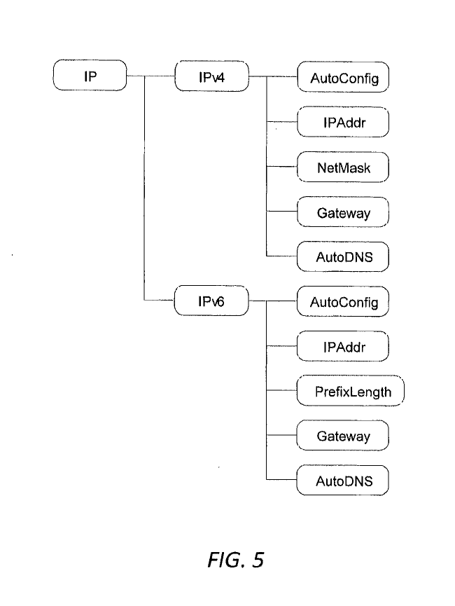

An example of OMA DM tree structure of the object “IP” of the tree structure of FIG. 4 is illustrated in FIG. 5. The different nodes of this tree structure may be defined in the following manner:

The object “MAP/X/IP” is the parent node of the IP sub-tree structure. This node 5 describes the IPv4, IPv6 addressing. The IPv4, IPv6 addresses are assigned statically by the DHCP server which may be installed on the mobile server 10. The domain names are managed dynamically in cooperation with an external Domain Name Server (DNS).

The object “MAP/X/IP/IPv4” defines the IPv4 address configuration. The object “MAP/X/IP/IPv4/AutoConfig” indicates whether the terminal can itself carry out its IP autoconfiguration. The object “MAP/X/IP/IPv4/IPAddr” defines the IPv4 address. The object “MAP/X/IP/IPv4/NetMask” defines the IPv4 network mask. The object “MAP/X/IP/IPv4/Gateway” defines the address of the IPv4 gateway of outlet of network to which is connected the mobile server 10. The object “MAP/X/IP/IPv4/AutoDNS” enables the activation of the automatic configuration of the DNS address in IPv4 addressing, for example using the protocol [RFC2132].

The object “MAP/X/IP/IPv6” defines the IPv6 configuration address. The object “MAP/X/IP/IPv6/AutoConfig” indicates whether the terminal can itself carry out its IP autoconfiguration. The object “MAP/X/IP/IPv6/IPAddr” defines the IPv6 address. The object “MAP/X/IP/IPv6/PrefixLength” defines the length of the prefix of IPv6 address [RFC4291]. The object “MAP/X/IP/IPv6/Gateway” defines the IPv6 gateway. The object “MAP/X/IP/IPv6/AutoDNS” defines the activation of the automatic configuration of the DNS address in IPv6 addressing, for example using the protocol [RFC2132].

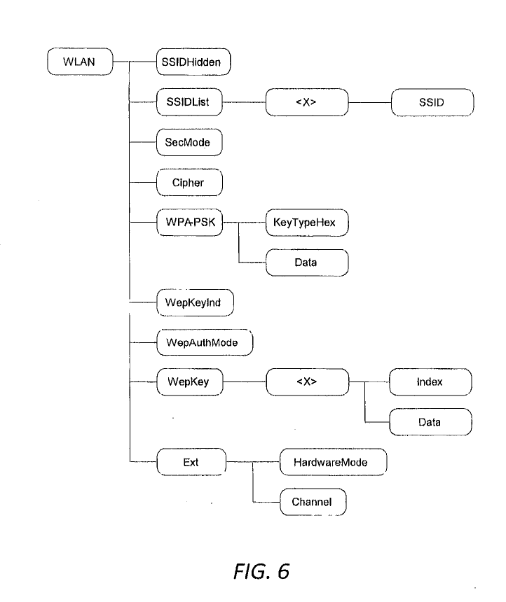

An example of OMA DM tree structure of the object “WLAN” of the tree structure of FIG. 4 is illustrated in FIG. 6. The different nodes of this tree structure may be defined in the following manner:

The object “MAP/X/BearerParams/WLAN” defines the specific connectivity parameters to establish a WLAN 42 communication link with a terminal 40, 50 on the terminal communication module WLAN 126.

The object “MAP/X/BearerParams/WLAN/SSIDHidden” indicates whether the identifier of the sub-network is hidden (TRUE value) or not (FALSE value).

The object “MAP/X/BearerParams/WLAN/SSIDList” defines the list of additional sub-network identifiers.

The object “MAP/X/BearerParams/WLAN/SSIDList/X” indicates that only one sub-network identifier is supported for the WLAN access point.

The object “MAP/X/BearerParams/WLAN/SSIDList/<X>/SSID” indicates the sub-network identifier.

The object “MAP/X/BearerParams/WLAN/SecMode” defines the security mode for the WLAN communication link 42.

The object “MAP/X/BearerParams/WLAN/Cipher” defines the cipher encryption 10 used on the WLAN communication link 42.

The object “MAP/X/BearerParams/WLAN/WPA-PSK” defines the parameters of the known mode of Wifi encryption Protected Access Pre-Shared Key (WPA-PSK).

The object “MAP/X/BearerParams/WLAN/WPA-PSK/KeyTypeHex” indicates whether the WPA-PSK data are supplied in the form of a sequence of hexadecimal numbers or not.

The object “MAP/X/BearerParams/WLAN/WPA-PSK/Data” makes it possible to supply the WPA-PSK key.

The object “MAP/X/BearerParams/WLAN/WepKeylnd” defines the index of the WEP key (from 0 to 3).

The object “MAP/X/BearerParams/WLAN/WepAuthMode” specifies the known Wired Equivalent Privacy (WEP) mode of authentication.

The object “MAP/X/BearerParams/WLAN/WepKey” defines the length and the data for the WEP key.

The object “MAP/X/BearerParams/WLAN/WepKey/X” defines the different WEP keys.

The object “MAP/X/BearerParams/WLAN/WepKey/X/Index” indicates the index of the WEP key. For example, the index may be a whole number comprised between 1 and 3 and a first key may be saved under the index 0, a second under the index 1, etc.

The object “MAP/X/BearerParams/WLAN/WepKey/X/Data” indicates the WEP key which may be, for example, of a length of 5 octets or instead 13 octets.

The object “MAP/X/BearerParams/WLAN/Ext” makes it possible to define ancillary parameters.

The object “MAP/X/BearerParams/WLAN/Ext/HardwareMode” defines the version of the WLAN ETSI (802.11) protocol used (a/b/g/n with optionally an indication of the width of the channel (20 or 40 MHz) and whether it is the upper or lower part that is used (for 40 MHz).

The object “MAP/X/BearerParams/WLAN/Ext/Channel” defines the WLAN channel (for example a logical identifier ranging from 0 to 11, 13 or 14).

The objects “MAP/X/BearerParams/WLAN/Ext/HardwareMode” and “MAP/X/BearerParams/WLAN/Ext/Channel” are specific to the management of the connectivity of the terminals 40, 50, that is to say at the access interface 120 of the terminals 40, 50 to the mobile server 10, and do not have any sense for the access interface 110 to the networks 20, 30 called interface “Network Access Point” (NAP).

Implementation of the Invention

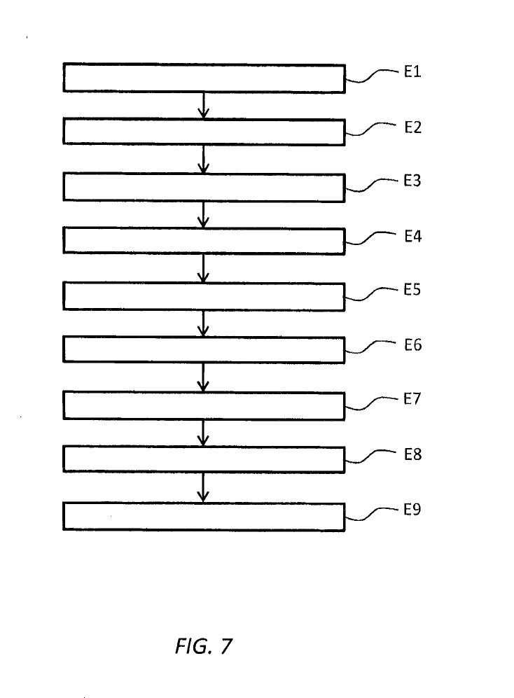

An example of implementation of the invention will now be presented with reference to FIG. 7.

In this example, the mobile server 10 is connected beforehand to at least one of the networks 20, 30. Obviously, the mobile server 10 can connect to a network 20, 30 during the steps of connection of a terminal 40, 50 to said mobile server 10.

The module 132 for managing connections of the mobile server 10 extracted, in step E1, from the associated object (for example WLAN) of the storage area 138 one or more associated connectivity parameter values, such as for example the Service Set Identifier (SSID) of the terminal communication module WLAN 126 which it distributes to the terminals that wish to connect to the mobile server 10 to communicate through one network or the networks 20, 30.

In a step E2, the terminal 40, 50 initialises a connection with the mobile server 10 at the level of the transport layer, for example WLAN (from the SSID WLAN emitted by the mobile server 10) or LAN. In a step E3, the mobile server 10 receives from the terminal 40, 50 an access control information item, for example its MAC physical address, and the access control module 133 checks, in a so-called filtering step E4, from the MAC physical address received and the filtering rules extracted (in a step E5) from the storage area 138, that the terminal 40, 50 is not prohibited from connecting to the mobile server 10 to communicate through one network or the networks 20, 30.

The module 134 for managing the configuration of the IP protocol network of the mobile server 10 extracted from the storage area 138 of IP configuration values in a step E6 and allocates notably an IP address network to the terminal 40, 50 which supplies it in a step E7.

The module 135 for managing the authentication then manages (locally or remotely) the authentication of the terminal 40, 50 in a step E8, for example, from the type of authentication server (Radius, Terminal Access Controller Access-Control System (TACACS), etc.), of the type of local authentication (identifier, password) or remotely (IP configuration of the server, secret key), etc.

When the terminal 40, 50 is authenticated, it is authorised to communicate, via the associated terminal communication module 122, 124, 126 and at least one network communication modules 112, 114, 116, through one network or the networks 20, 30 via the mobile server 10 in a step E9.

The mobile server according to the invention thus enables a plurality of terminals to connect to said server via a plurality of terminal communication modules of different types to communicate with one or more networks. Such a connectivity is managed by the use of a tree structure of OMA type grouping together the connectivity parameters using the OMA DM protocol. Such a structure is stored locally in the mobile server which thus no longer has notably to search systematically for the values of these parameters in one of the networks.

The use of the open OMA model makes it possible to create objects specific to the mobile server to manage different types of local communication links (WLAN, LAN, USB, etc.) using an efficient, open and simple protocol and tree structure.

1. A mobile server for managing the connectivity of at least one terminal for communicating through one or a plurality of telecommunications networks, the mobile server comprising:
at least one terminal communication module configured to communicate with said terminal;
a plurality of network communication modules configured to communicate with a plurality of telecommunications networks;
a storage area in which are stored connectivity parameter values of the terminal enabling the terminal to connect to the mobile server,
the mobile server being configured to:
connect to the plurality of telecommunications networks via the plurality of network communication modules,
extract a set of connectivity parameter values of the terminal from the storage area,
allow or not allow, on the basis of the extracted set of connectivity parameter values, a connection of the terminal via at least one of the terminal communication modules so that the terminal communicates applicative data through at least one of the telecommunications networks via said at least one of the terminal communication modules and at least one of the network communication modules.

2. The mobile server according to claim 1, wherein the connectivity parameters are organised in the storage area in the form of a tree structure including a plurality of hierarchized objects each grouping together one or a plurality of connectivity parameters.

3. The mobile server according to claim 2, wherein the tree structure is based on the Open Mobile Alliance (OMA) model and wherein the objects are manipulated using the Open Mobile Alliance Device Management protocol.

4. The mobile server according to claim 1, wherein said mobile server is configured to establish a connection with a terminal via at least one of the terminal communication modules, to exchange information items enabling the access control of the terminal and/or a network addressing configuration of the terminal.

5. The mobile server according to claim 1, wherein said mobile server is configured to analyse and/or to compare an information item received from a terminal enabling the access control of said terminal from the set of connectivity parameter values extracted from the storage area.

6. The mobile server according to claim 1, wherein said mobile server is configured to determine a network addressing configuration of the terminal from a set of network addressing configuration parameter values extracted from the storage area.

7. The mobile server according to claim 1, wherein said mobile server is configured to enable the authentication of the terminal locally from authentication parameters stored in the storage area or instead remotely while communicating with an authentication server situated in one of the networks.

8. A system for managing the connectivity of at least one terminal to at least one telecommunications network, said system comprising:
at least one telecommunications network;
a mobile server according to claim 1,
at least one terminal configured to:
establish a connection via at least one of the terminal communication modules to exchange information items enabling access control of said terminal and/or a network addressing configuration of said terminal and/or,
communicate applicative data through at least one of the telecommunications networks via at least one of the terminal communication modules and at least one of the network communication modules.

9. A method, implemented by a mobile server according to claim 1, for managing the connectivity of at least one terminal for the communication of the terminal via the mobile server through one or a plurality of telecommunications networks, the method comprising:
connecting to at least one of a plurality of telecommunications networks via at least one of the plurality of network communication modules,
extracting a set of connectivity parameter values of the terminal from the storage area,
allowing or not allowing, from the extracted set of connectivity parameter values, the connection of the terminal via at least one of the terminal communication modules so that the terminal communicates applicative data through at least one of the telecommunications networks via said at least one of the terminal communication modules and at least one of the network communication modules

10. The method according to claim 9, the method comprising:
connecting the terminal via at least one of the terminal communication modules to exchange information items enabling the access control of the terminal and/or a network addressing configuration of the terminal and/or,
analysing and/or filtering an information item received enabling the access control of a terminal from the set of connectivity parameter values extracted from the storage area, and/or,
determining the network addressing configuration of a terminal from a set of network addressing configuration parameter values extracted from the storage area, and/or
supplying to the terminal one or more values of the set of connectivity parameter values extracted from the storage area, and/or,
authenticating the terminal, locally from authentication parameters stored in the storage area or instead remotely while communicating with an authentication server situated in one of the networks and/or,
communication of a terminal through the network or networks via the terminal communication module and at least one network communication module.

11. A non-transitory machine readable support comprising instructions executable by a computer for the implementation of the method according to claim 9.

12. The mobile server according to claim 4, wherein the at least one of the terminal communication modules is of WLAN or LAN type.

13. The method according to claim 10, wherein authenticating the terminal, locally from authentication parameters stored in the storage area or instead remotely while communicating with an authentication server situated in one of the networks is done using an authentication protocol based on the known norm 802.1x.
